(19) United States
(12) Patent Application Publication
(10) Pub. No.: US 2004/0204032 A1
(43) Pub. Date: Oct. 14, 2004

(54) Wireless communication system using variable band width

(75) Inventors: Atsushi Hisano, San Jose, CA (US); Shigeko Otani, Fremont, CA (US)

Correspondence Address: FOLEY AND LARDNER, SUITE 500, 3000 K STREET NW, WASHINGTON, DC, 20007, US

(73) Assignee: Omron Corporation

(21) Appl. No.: 10/230,389

(22) Filed: Aug. 29, 2002

(51) Int. Cl. H04Q 7/20; H04M 1/00; H04B 1/38

(52) U.S. Cl. 455/552.1; 455/426.1

(57) ABSTRACT

Both a first wireless communication network (for instance, Control Channel) capable of operating at a low-speed but a reduced communication rate and a second wireless communication network (for instance, CDPD) capable of operating at a high-speed but an expensive communication rate are used in a wireless communication terminal. The former is normally used, whereas the latter is used only when a predetermined event happens. For this purpose, a plurality of sets of both subscriber identification information and wireless communication terminal identification information, which may be used commonly for subscribers, is provided in advance. Based on the information provided by a subscriber using the first wireless communication channel, one of the sets is set in the wireless communication terminal to temporarily use the second wireless communication channel. A daily service for monitoring, e.g., the position of a vehicle using the first wireless communication network and a specific service for supplying visual images and/or audible sounds in an emergency or accident using the second wireless communication network can be received at a reduced cost.

### BACKGROUND OF THE INVENTION

1. Field of the Invention

The present invention relates to a wireless communication system in which the wireless communication can be carried out at a low cost and in a legal process, using a wireless communication channel capable of operating at a low-speed but a reduced communication rate in a normal case, and another wireless communication channel capable of operating at a high-speed but an increased communication rate, when a certain event happens.

2. Description of the Related Art

After the stages of research and trial manufacture, it now arrives at the stage of putting to practical usage the telematics, in which various vehicle information services, such as the tele-diagnosis and tele-moniting of a vehicle, the pursuit of vehicles, the usage of internet in a vehicle, road map service and others, can be realized by determining the current position and by carrying out a wireless communication to an external, using a GPS and a wireless communication device which are both installed in a vehicle. The OnStar by General Motors, which is typical in such a telematics, is described regarding the content of the service in the following Web Page:

http://www.OnStar.Com/visitors/html/ao_features.htm

A close study of the services described therein reveals that there are several services, which cannot be received when a driver uses a cellular phone in a vehicle.

That is, the item “large capacity information, such as a visual image and/or audible sounds, representing a scene and the origin of an extraordinary situation or an emergency situation, is automatically detected with a sensor, and the information thus detected is sent by wireless to the outside of the vehicle, thereby enabling suitable instructions or necessary information to be received from the outside as audible sounds and/or visual images, using a wireless communication” can be found.

In this case, there are problems regarding both the charge for the service and the communication rate for using the wireless communication network. In U.S.A, it is believed that a user cannot accept a charge for the fleet management service of a commercial vehicle per month, unless it is less than 30 to 50 dollars. Accordingly, it can be recognized that 15 to 25 dollars per month can be accepted in the charge for a telematics service of a private car. On the other hand, a basic charge per month of 20 to 30 dollars is required in U.S.A. for the service of a cellar phone having a communication rate capable of transmitting visual images. Furthermore, the service charge of the Control Channel, which can be operated on the AMPS network covering almost all of the areas in U.S.A., and can transmit a very small amount of data (several tens bits per minute), is 8 dollars or so per month. From these facts, it follows that a private person, who is able to pay 15 to 25 dollars per month, can receive a telematics service in which the positional information (information regarding the latitude and longitude being expressed by several tens bits) from a GPS can be transmitted via the Control Channel to pursue a vehicle.

In the case of emergency, however, there still exists a strong need that “large capacity information, such as visual images and/or audible sounds, representing a scene and the origin of an extraordinary situation or an emergency situation, is automatically detected with a sensor, and the information thus detected is sent by wireless to the outside of the vehicle, thereby enabling suitable instructions or necessary information to be received from the outside as audible sounds and/or visual images, using a wireless communication” by utilizing a high speed wireless communication channel is used. In the E911 scheme currently forwarded in U.S.A, it is intended that, when an emergency is informed via a cellular phone, the position of a transmitter is exactly identified from the cellular phone and a rescue party rushes to the accident spot at the location of the cellular phone. The final accuracy in determining the position will be expected to be less than 50 m. If the E911 scheme will be realized, it will be desired in the following stage that a suitable action should be carried out on the basis of the supplied visual images and/or audible sounds sent at the accident spot. Hence, from the viewpoint of the E911 scheme, the above-mentioned need will also become strong (there also exist needs for a high speed wireless communication of visible images and/or audible sounds, when an extraordinary situation or an emergency situation for a person not only in a vehicle but also in a bicycle or even for a walking person).

Since such an extraordinary situation or an emergency situation happens with a very small frequency, it is conceivable that a service for such a situation can be provided using a high speed wireless communication channel with a time sharing method. Accordingly, when such an event occurring at a very low frequency happens, a high-speed wireless communication can be carried out by temporally using both subscriber identification information and wireless communication terminal identification information for the high-speed wireless communication service. As a rational solution, the communication rate for using the high-speed communication network is paid either commonly by persons who use the network for transmitting both the subscriber identification information and the wireless communication terminal identification information in the time-sharing method, or by a person or a party providing a common service to these persons.

In Japanese Unexamined Patent Publication No. 2002-78014, a technique “a mobile communication network subscriber information storing apparatus comprising: memory means for storing a subscriber information used in order that a mobile communication terminal carries out a communication on a first wireless communication mode in a mobile communication network; register means for registering in said memory means an identification information used in order that the mobile communication terminal permits using the subscriber information; and wireless communication means for transmitting the subscriber information stored in said memory means to said mobile communication terminal on a second wireless communication mode corresponding to said identification information” is disclosed. With this technique, the following problem has been solved: “when a subscriber selectively uses one of MS's (mobile stations) including a telephone, a PC for data communication, a small-sized mail terminal and the like, a long time is required to remove a SIM (subscriber ID module) from the MS and then to adapt it to an MS to be communicated, thereby requiring much labor for exchanging the SIM. If, moreover, the receipt of communication is intended using an ordinary used MS, for instance, a telephone, the SIM always has to be inserted into the telephone terminal, and further the SIM card must always be brought back to the telephone, when the communication via an MS, such as a PC for data communication, a small-sized mail terminal or the like for emergency is completed. In addition, it is not necessary to exchange the SIM in which the subscriber ID is written, and it is possible to selectively use one of the mobile communication terminals held by the subscriber.

In accordance with the technique, a single SIM can be used for a plurality of terminals. However, there are the following problems:

(1) Unless the SIM is located within a range of communication at a very small distance relative to the mobile communication terminal, the subscriber ID cannot be transmitted to the mobile communication terminal, so that the mobile communication terminal cannot be used.

(2) A user has to determine to what mobile communication terminals the information of the SIM is communicated.

U.S. Pat. No. 5,946,356 describes a system for communicating between a base station and a wireless communication terminal, wherein the wireless communication terminal periodically inquiries whether or not a big data must be supplied from the base station to the wireless communication terminal using a forward Control Channel, when the wireless communication terminal is not communicated to the base station using a supplementary communication means. If such a big data must be transmitted, the communication state changes to those in which the supplementary communication channel is used. In this art, however, the communication rate for always ensuring the usage of the supplement communication channel is not taken into account. As a result, the usage of this technique makes it impossible to use the supplementary communication channel at a low cost.

In U.S. Pat. No. 6,167,251, a cellular phone includes a plurality of modules permitting only one time the authorized usage of the wireless communication network in the payment on delivery. These modules are stored in a mountable time charge cartridge and the cellular phone is equipped with the modules. When the wireless communication network is used, the communication is carried out, using one of the modules payable on delivery. However, this approach provides no reduction in the communication cost, since the communication rate is paid by the user himself and also paid on delivery.

U.S. Pat. No. 5,805,209 describes a technique wherein visual images are sequentially received and a few latest images are stored in an image memory, and the visual signal is read and transferred to a memory, when a trigger signal is received. However, there is no description as to how the visual images are transmitted at a low cost using a wireless communication network.

### SUMMARY OF THE INVENTION

Accordingly, it is a first object of the present invention to transmit a big capacity data via a high-speed wireless communication network at a low cost, using both a subscriber identification information (Mobile IDentification Number (MIN)) and a wireless communication terminal identification information (Electronic Serial Number (ESN)) which are used together with the other subscribers, when an event happens and it is required to transmit/receive such a big capacity data as visual images and/or audible sounds.

Furthermore, it is a second object of the present invention to transmit a big capacity data such as visual images and/or audible sounds via a high-speed wireless communication network at a low cost, using both a subscriber identification information and a wireless communication terminal identification information, which are used together with the other subscribers, when the occurrence of an extraordinary situation or an emergency situation, such as a traffic accident, a burglar or the like, is detected either automatically or by a personal input in a mobile element, such as a vehicle, walking person or the like, thereby enabling the data of visual images and/or audible sounds representing a scene or the origin of such an extraordinary situation or an emergency situation to be stored in another location at a low cost and at the same time to be reported to an appropriate person or a party.

Further objects, significant features and advantages of the present invention will be fully recognized from the following description.

In accordance with the invention, the first object is attained by the following procedures: A wireless communication is carried out at a wireless communication terminal, using a first wireless communication channel (for instance, Control Channel) capable of operating at a low speed, but at a reduced communication rate in the normal mode. When, however, a predetermined event happens, a second wireless communication channel (for instance, CDPD) capable of operating at a high speed, but at an increased communication rate, is employed. For this purpose, one of several sets of both subscriber identification information and wireless communication terminal identification information, said sets being commonly provided in advance for an available usage, is set in the wireless communication terminal on the basis of information supplied from a subscriber using the first wireless communication channel, and the second wireless communication channel capable of operating at a high speed is temporarily used.

In accordance with the present invention, the second object is attained by the provision of a sensor for continuously sensing visual images and/or audible sounds; a sensing data memory for storing a plurality of sensing data sensed by the sensor; and a reading unit for reading at least more than one of sensing data just before the moment of a predetermined event happening from the sensing data memory, whereby, in order to use a second wireless communication channel capable of operating at a high speed, but at an increased communication rate when the predetermined event happens, one of several sets of both subscriber identification information and wireless communication terminal identification information, said sets being commonly provided in advance for an available usage, is set in the wireless communication terminal on the basis of information supplied from a subscriber using a first wireless communication channel, and the second wireless communication channel capable of operating at a high speed is temporarily used, and then more than one of the sensing data just before the moment at which the event happens is transmitted to a destination.

Hereinafter, the Control Channel will be briefly described. The Control Channel is a digital channel which is used to connect and control network circuits in the analog cellular phone service AMPS, in which case, the subscriber identification information (Mobile IDentification Number (MIN)) and the wireless communication terminal identification information (Electronic Serial Number (ESN)) are used. The AMPS includes 832 channels having a bandwidth of 30 KHz, and 42 of these channels are used as the Control Channel in order to connect and control the network circuits. The other channels are used as analog sound channels. Moreover, the Control Channel includes a Forward Control Channel (FOCC) and a Reverse Control Channel (RECC). The FOCC is used to supply information from a base station to a mobile station, whereas the RECC is used to supply information from the mobile station to the base station. The Control Channel is used for the digital transmission and a high reliability in the communication, because it consumes a greater power of transmission than the sound channel. In recent years, data having a small amount of content are mutually transmitted between a wireless communication terminal and a base station in a reduced communication rate service, using the Control Channel.

In conjunction with the above, the CDPD will be briefly described. The CDPD (Cellular Digital Packet Data) is a packet data communication scheme in which the TDMA/AMPS cellular phone network is used. The CDPD can be regarded as a system constructed on the AMPS and therefore is completely compatible with the AMPS. The CDPD can transmit “a data frame at a maximum rate of 19.2 Kbps, temporarily using a non-used transmission channel of 30 KHz, if it exists”. The CDPD can transmit the data packet in a sound channel without any influence on the quality of audible sounds. However, since the CDPD has many overheads, the actual transmission rate is restricted within 9600 bps or so.

Further objects, features and advantages of the present invention will become apparent from the following description of the preferred embodiments with reference to the attached drawings.

### BRIEF DESCRIPTION OF THE DRAWINGS

FIG. 1 is a diagram showing the total system to which the present invention is applicable.

FIG. 2 is a diagram showing an example of an available ID table.

FIG. 3 is a diagram elucidating a status table of a wireless communication terminal.

FIG. 4 is a diagram elucidating a status table of available ID.

FIG. 5 is a flow chart of a process “allocating available ID” executed in a service center 110.

FIG. 6 is a flow chart of a process “sensing the completion of treatments in which available ID is used at a wireless communication terminal” executed in the service center 110.

FIG. 7 is a table indicating the treatment content in accordance with the event code.

### DESCRIPTION OF THE PREFERRED EMBODIMENTS

Referring now to drawings which show specific features of the preferred embodiments, the present invention will be described in detail.

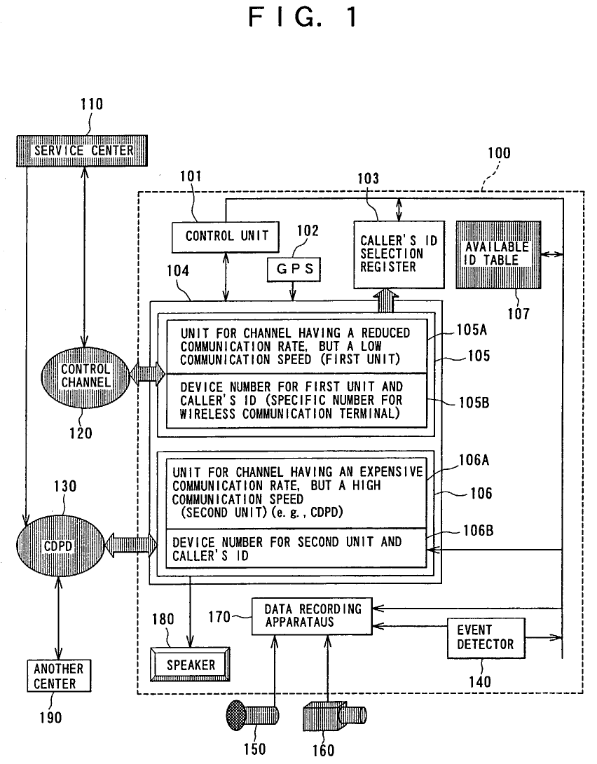

Referring to FIG. 1, the function of a wireless communication terminal 100 will be described. Although only one wireless communication terminal 100 is shown in FIG. 1, it is assumed that many wireless communication terminals 100 are actually positioned at various locations and are constituted capable of being connected either to a Control Channel network 120 or to a CDPD network 130. In a certain case, there is a possibility that the wireless communication terminal 100 cannot be connected to such a network by wireless communication in accordance with a communication circumstance, even when it resides either outside or inside one or both of the service areas for the Control Channel network 120 and the CDPD network 130.

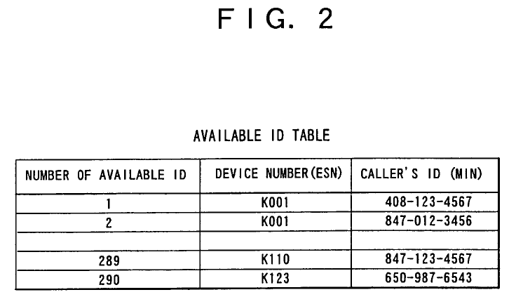

FIG. 2 shows a table for pairs of the device numbers (Electronic Serial Number (ESN)) and caller's ID's (Mobile IDentification Number (MIN)) registered in advance in a carrier for managing the connected CDPD network 130 as an available ID necessary for the wireless communication via the CDPD network 130, using a second wireless communication unit. The device number and caller's ID recorded in this table are restricted to those subscribers who assent to the carrier, when they are used in a time sharing mode within a range of the wireless communication apparatus 100 which is controlled by the service center 110. In each available ID recorded in such an available ID table, the device number and the caller's ID are combined with each other as a paired data. The table is stored in both the service center 110 and each wireless communication terminal 100.

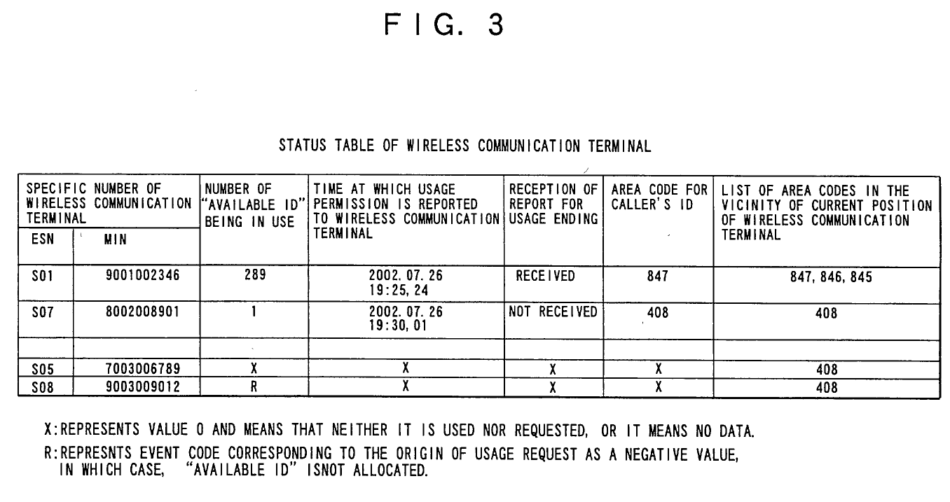

FIG. 3 shows a status table of wireless communication terminals 100, which are controlled by the service center 110 and can be connected to the Control Channel network 120 and the CDPD network 130. The status table is stored in an inner memory of a control unit 101. Moreover, “the available ID being in use”, “the time at which the permission of usage is reported to the wireless communication terminal”, “the receipt/non-receipt of the report regarding the ending of usage”, “the area code of caller's ID” and “the list of the area codes in the vicinity of the current location of the wireless communication terminal” are recorded for each specific number (a set of ESN and MIN). In the column of “available ID” being in use, the code of the event caused by the origin of the usage request is set as a negative value R, when the usage is requested, and “the available ID” is not yet allocated, whereas, when “available ID” is neither requested to be used, nor yet used, the code representing the value zero is set. When it is used, the number of “the available ID” number being in use (which is defined in the available ID table in FIG. 2) is set. The area code of the caller's ID is determined in the available ID table of FIG. 2 by the index of “the available ID” being in use stored as an available ID, and then the value of the area code (first set of three numerals in the caller's ID of FIG. 2) is stored in the area code of caller's ID.

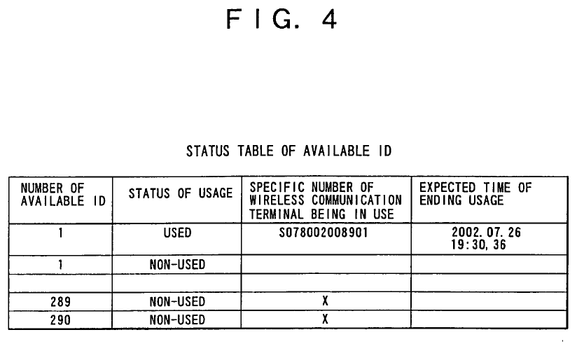

FIG. 4 shows “a table of available ID status”, which is controlled by the service center 110 and stored therein. For each serial number of the available ID, the status of usage, the specific number of the wireless communication terminal being in use and the expected time at which the usage will be finished, are managed and stored.

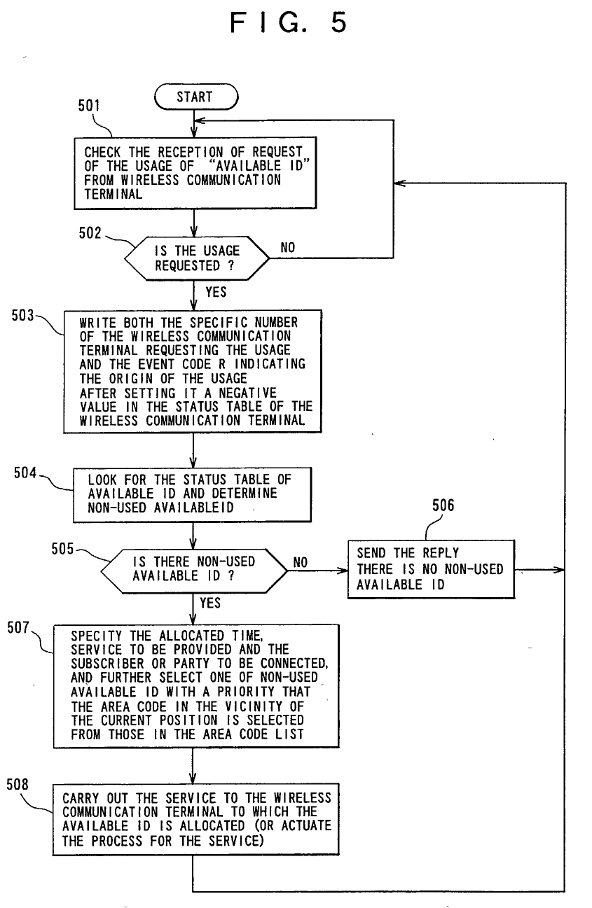

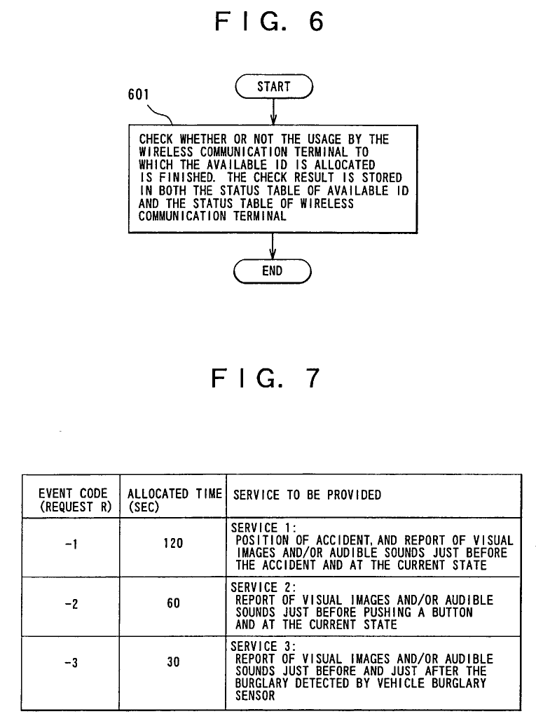

FIG. 6 shows another process which is executed parallel to the process carried out by the service center 110 shown in FIG. 5. In this process, the end in the usage of the available ID, which is allocated to the wireless communication terminal 100, is always checked by means of the report on the end from the wireless communication terminal 100. When the report on the end is not supplied from the wireless communication terminal 100 till the usage ending time, the service center renews the communication to the wireless communication terminal using the CDPD network 130, the available ID status table which is determined by ending the service on basis thereof and ending the process, and the status table of the wireless communication terminal.

The process content tables for each event code in FIG. 7 is stored in both the service center 110 and the wireless communication terminal 100.

Description of the Wireless Communication Terminal

As shown in FIG. 1, the control unit 101, a GPS receiving apparatus 102, a caller's ID selection register 103, a wireless communication section 104, a first wireless communication unit 105, a second wireless communicating unit 106, an available ID table 140, a data recording apparatus 170 and a speaker 180 are built in the wireless communication terminal 100. As shown in FIG. 2, the list of available ID's via the second wireless communication unit is stored in the available ID table. The same list is also stored in the service center 110. The first wireless communication unit 105 comprises a first unit 105A as a device necessary for communicating to the other subscriber or party via the Control Channel network 120, device serial numbers (ESN) as data necessary for connecting and controlling the first unit 105A, and a unit 105B for storing the caller's ID's (MIN). In this case, the data stored in the unit 105B are specific serial numbers of the wireless communication terminals 100.

The second wireless communication unit 106 comprises a second unit 106A as a device necessary for communicating to the other subscriber or party via the CDPD network 130, a device serial number (ESN) as data necessary for connecting and controlling the second unit 106A, and a unit 106B for storing the caller's ID's (MIN). The data stored in the unit 106B are read out from the available ID table 107 on the basis of the available ID serial number specified by the caller's ID setting register 103 and then the data is stored by the control unit 101, when the CDPD network 130 has to be used. The first wireless communication unit 105 as well as the second wireless communication unit 106 is equipped with devices necessary for the wireless communication, together with antennas for the wireless communication.

The wireless communication terminal 100 periodically transmits the positional information (for instance, latitude and longitude) determined by the GPS receiving apparatus 102 using the first wireless communication unit 105, together with the specific serial number of the wireless communication terminal 100 (a set of ESN and MIN for the first unit), to the service center 110, using only the Control Channel which is operated on, e.g., an AMPS (Advanced Mobile Phone System) network. Moreover, a television camera 160 and a microphone 150 are connected to the wireless communication terminal 100, so that the visible images and/or audible sounds are continuously digitized and the data thus digitized are supplied to a data recording apparatus 170. Since the storage capacity of the data recording apparatus 170 is restricted, the old data are eliminated and then new data are sequentially stored in the form of a First In First Out (FIFO) scheme. The data recording apparatus 170 is connected to the second wireless communication unit 106, and thereby may transmit the data (visible images and/or audible sounds) recorded within a predetermined time interval just before the moment at which an event sensing signal is supplied from an event sensor 140 and the data recorded within a predetermined time interval after the above-mentioned moment to the outside under the control condition by the control unit 101, using the second wireless communication unit 106.

The usage of the Control Channel for the first wireless communication unit 105 is due to the fact that it provides a low transmission speed, but requires a reduced charge rate of communication. The Short Message Service also provides a low transmission speed, but it requires a reduced charge rate of communication. The Short Message Service can also be used in the first wireless communication unit 105. In this embodiment, however, it is assumed that the Control Channel is used in the first wireless communication unit 105.

When the event detector 140 detects a predetermined event, and then an event-sensing signal is supplied therefrom to the control unit 101, the control unit 101 starts to switch from the communication using the first wireless communication unit 105 to the communication using the second wireless communication unit 106. The event detector 140 can serve to detect an impact in the collision of, for example, a vehicle equipped with the wireless communication terminal 100, as an event, with the aid of an accelerating sensor. In another embodiment, an emergency button to be pushed by a driver on a vehicle or by a walking person can be used as an event detector 140. Alternately, another sensor (for instance, gas sensor, temperature sensor, radiation sensor or the like) can also be used as an event detector which detects an abnormal value to indicates an event. The event-sensing signal is encoded in accordance with the type of the detected event, as shown in the table of FIG. 7.

In any case, whenever a predetermined event is detected by the event detector 140, the control unit 101 uses the Control Channel to switch the network, and then informs a request of switching as an event code to the service center 110. The request of switching is used to request to the service center 110 the ID usage permission of one of the available ID's which are provided to use a wireless communication channel capable of operating at a higher speed than that of the Control Channel. For the sake of simplicity, it is assumed in this embodiment that the wireless communication channel capable of operating at such a high speed is the CDPD network. Of course, either a channel on a wireless communication network using the CDMA communication scheme or a channel using another high-speed wireless communication scheme can also be used other than the channel on the CDPD network.

One or more of wireless communication terminals 100 request the ID usage permission of one of available ID's for dealing with the event indicated by the event code via the Control Channel network 120 to the service center 110, using the first wireless communication unit 105 as occasion arises. In this case, of course, there is a possibility that several wireless communication terminals 100 have no need of request and the other wireless communication terminals are using one of the available ID's.

After receiving the notice of the allocated available ID number from the service center 110, the wireless communication terminal 100 sets the number in the caller's ID selection register 103, and then the control unit 101 accesses the available ID table 107, using the value set in the caller's ID selection register 103 as an index. Thereby, the control unit 101 reads the device serial number (ESN) and the caller's ID (MIN), and sets these values in a memory area 106B of the second wireless communication unit, so that it is possible to communicate via the CDPD network. When the wireless communication terminal 100 enables to carry out the communication via the CDPD network, the terminal 100 starts to execute a program for executing the service corresponding to the event code, which the terminal 100 has informed to the service center 110. For instance, when the notified event code is, e.g., “−1”, as shown in FIG. 7, the started program is the Service 1. In this case, the program provides a service of communication to the service center 110, using the CDPD network 130 which is a higher speed wireless communication network, compared with the Control Channel, during the allocated time of 120 sec, which corresponds to the Service 1 in FIG. 7. The content of the service is that “a piece of data on the visible images and/or audible sounds recorded in the data recording apparatus 170, said piece being recorded just before and just after the receipt of the event signal, is transmitted to the service center 110 and then sound data from the service center is output by the speaker 180.”

At the end of the service, the wireless communication terminal 100 notifies the end to the service center 110 using the CDPD network 130. Thereafter, the right of communication using the device serial number (ESN) and caller's ID's (MIN) on the CDPD network 130 specified by the available ID number is abandoned, thereby returning to the normal mode at which the positional information obtained by GPS 102 is periodically transmitted to the service center 110, using the Control Channel network 120. Of course, when the communication to the service center 110 via the CDPD network 130 cannot be carried out, the right of communication is abandoned, regarding it as an abnormal process, and then the communication is stopped, thereby returning to the normal mode at which the positional information obtained by GPS 102 is periodically transmitted to the service center 110, using the Control Channel network 120.

Alternately, there is a possibility that the wireless communication terminal 100 communicates information not to the service center 110, but to another center 190 for the process corresponding to the Service 1. In this case, the service center 110 and the wireless communication terminal 100 communicate the information to each other not via the CDPD network 130, but via the Control Channel network 120. That is, when the event detector 140 detects an event, a piece of visual image and audible sound data recorded by the data recording apparatus 170, said piece being recorded just before and just after the moment at which the event is detected, is sent to the another center 190 using the CDPD network 130. The wireless communication terminal 100 informs the end of the process corresponding to the Service 1 to the service center 110 via the Control Channel network 120.

Description of the Function of the Service Center

In the service center 110, the positional information periodically received from the wireless communication terminal 100 is renewed for each specific serial number of the wireless communication terminal 100 and then recorded in a table (not shown), so long as any event does not happen in the wireless communication terminal 100. Thereby, the service center 110 is always able to recognize the position of the wireless communication terminal 100. Moreover, as shown in FIG. 3, the area code in the vicinity of the position is extracted by referring to the area code information on the basis of the positional information, and then is written in the status table of the wireless communication terminal shown in FIG. 3.

FIG. 5 shows a flow chart of a process “allocating the available ID” to be executed in the service center 110.

At step 501, it is examined whether or not a request of allocating the available ID is sent from the wireless communication terminal 100 to the service center 110 via the Control Channel network 120. In the service center 110, the messages received from the wireless communication terminal 100 are always monitored using another communication process apparatus, and recorded therein by pairing the specific serial number of the wireless communication terminal 100 to the message, together with the received time. Accordingly, the reception of request can be recognized by looking for the received message at the step 501.

At step 502, it is judged whether or not more than one request of allocating an available ID (i.e., the request of usage) arrives at the service center. The request of allocating available ID (indicated by code R in FIG. 3) is expressed as an event code specified according to the origin of the request. It follows that the reception of the request leads to going to step 503, and the non-reception causes to return to the step 501.

At step 503, the event code R, which indicates the request of allocating the available ID, is written as a negative value in the status table of the wireless communication terminal shown in FIG. 3. The respective values of the request corresponding to R have the following meanings:

−1: the request of allocating an available ID due to the detection of an impact.

−2: the request of allocating an available ID due to the push of an emergency button.

−3: the request of allocating an available ID due to the burglary sensed by a vehicle burglary detection sensor.

At step 504, a non-used available ID is looked for, referring to the status table of available ID's. The judgment of the non-used available ID at step 505 causes to transfer to step 507. In this case, firstly referring to the process content table for the respective event codes shown in FIG. 7, the allocated time and the service to be provided are read. When a plurality of available ID's is not used, an available ID is selected among those in the status table of the wireless communication terminals shown in FIG. 3, with the priority that it coincides with the area code corresponding to the non-used available ID. Thereafter, the number of the available ID's selected is transmitted via the Control Channel network 120 to the wireless communication terminal 100, which requests the allocation of the available ID.

At step 508, referring to the process content table for the respective event codes shown in FIG. 7, the service process program corresponding to the event code (request R) starts to be executed, and at the same time, the time to be allocated on the basis of the event code is read and the expected time of the end of the usage in the available ID status table is recorded in the column of the number of the available ID to be allocated.

While the present invention has been described with reference to the preferred embodiments, it is to be understood that the present invention is not limited to the exemplified embodiments and that various modifications and equivalent arrangements are possible within the scope of the appended claims.

What is claimed is:

1. A wireless communication terminal apparatus comprising:
a first wireless communication unit for communicating to a service center, using a first wireless communication network capable of operating at a low speed;
an event detector for detecting a predetermined event to output an event information;
a second wireless communication unit for communicating to the service center, using a second wireless communication network capable of operating at a high speed;
request report means for reporting a request signal of allocating a set of subscriber identification information and wireless communication terminal identification information provided in advance to use said second wireless communication network to the service center, using said first wireless communication network, after receiving the report of the event information from the event detector; and
control means for storing data of a set of the subscriber identification information and the wireless communication terminal identification information which are both used to use the second wireless communication network in a memory which is available for said second wireless communication unit, said data of the set being obtained from the service center in response to the request from said request report means via the first wireless communication network, and for carrying out the wireless communication, temporarily using the second wireless communication network.

2. A wireless communication terminal apparatus comprising:
a first wireless communication unit for communicating to a service center, using a first wireless communication network capable of operating at a low speed;
an event detector for detecting a predetermined event to output an event information;
a second wireless communication unit for communicating to the service center, using a second wireless communication network capable of operating at a high speed;
a data recording apparatus connected to an image pick up apparatus and/or a microphone for sequentially recording new data of visual images and/or audible sounds after eliminating old data thereof;
request report means for reporting a request signal of allocating a set of subscriber identification information and wireless communication terminal identification information provided in advance to use said second wireless communication network to the service center using said first wireless communication network, after receiving the report of the event information from the event detector; and
control means for storing data of a set of the subscriber identification information and the wireless communication terminal identification information which are both used to use the second wireless communication network in a memory which is available for said second wireless communication unit, said data of the set being obtained from the service center in response to the request from said request report means via the first wireless communication network, and for sending by means of said data recording apparatus the data including those just before and just after the moment at which said event detector detects the event, temporarily using the second wireless communication network.

3. A wireless communication terminal apparatus comprising:
a communication unit for carrying out the wireless communication to a service center, using a first wireless communication network capable of operating at a low speed and a second wireless communication network capable of operating at a high speed;
a sensing data memory for storing a plurality of sensing data which are obtained by a sensor for continuously obtaining visual images and audible sounds;
a reading unit for reading out from said sensing data memory at least more than one of sensing data just before the moment at which a predetermined event happens; and
transmission control means for storing in said wireless communication terminal one of sets of subscriber identification information and wireless communication terminal information which are prepared in advance to commonly use the second wireless communication network when the predetermined event happens, on the basis of information provided by a subscriber, using the first wireless communication network, and for sending to a predetermined destination more than one sensing data just before the moment at which said event happens, temporarily using the second wireless communication network.

4. A service center for carrying out the wireless communication to wireless communication terminal apparatuses, using a first wireless communication network capable of operating at a reduced speed and a second wireless communication network capable of operating at a high speed, said service center comprising:
first memory means for storing a plurality of sets of subscriber identification information and wireless communication terminal identification information as corresponding available ID's which are preset for using said second wireless communication network;
second memory means for storing the status of allocating each of said available ID's to the wireless communication terminal apparatus; and
allocation means for identifying non-used available ID, referring to said second memory means, when a request of allocating the available ID to the wireless communication terminal apparatus is received, and for allocating the non-used available ID for said second wireless communication network to the wireless communication terminal apparatus which supplies said request assuming that the available ID thus identified can be temporarily used.

5. A service center for carrying out the wireless communication to wireless communication terminal apparatuses, using a first wireless communication network capable of operating at a reduced speed and a second wireless communication network capable of operating at a high speed, said service center comprising:
first memory means for storing a plurality of sets of subscriber identification information and wireless communication terminal identification information as corresponding available ID's which are preset for using said second wireless communication network;
second memory means for storing the status of allocating each of said available ID's to the wireless communication terminal apparatus; and
allocation means for identifying non-used available ID, referring to said second memory means when a request of allocating the available ID to the wireless communication terminal apparatus is received, together with information about the type of allocation, along with determining an allocated time capable of using the second wireless communication network using said information about the type of allocation, and for allocating both said the non-used available ID for said second wireless communication network and said allocated time to the wireless communication terminal apparatus which supplies said request assuming that the available ID thus identified can be temporarily used.
